(19) United States
(12) Patent Application Publication
(10) Pub. No.: US 2016/0261526 A1
(43) Pub. Date: Sep. 8, 2016

(54) COMMUNICATION APPARATUS AND PROCESSOR ALLOCATION METHOD FOR THE SAME

(71) Applicant: FUJITSU LIMITED, Kawasaki-shi (JP)

(72) Inventor: Takeshi KODAMA, Yokohama (JP)

(21) Appl. No.: 15/018,739

(22) Filed: Feb. 8, 2016

(30) Foreign Application Priority Data
Mar. 3, 2015 (JP) 2015-041125

(51) Int. Cl. H04L 12/935; H04L 12/721; H04L 12/931

(52) U.S. Cl. CPC H04L 49/3018; H04L 49/352; H04L 45/38

(57) ABSTRACT

A communication apparatus includes: a memory; processors coupled to the memory; and a network interface card configured to distribute a received packet to one of the processors in accordance with a distribution rule, wherein one or more processors of the processors execute: a management process of managing a correspondence between a flow to which the received packet belongs and a distribution destination processor of the processors of the received packet determined in accordance with the distribution rule, a schedule process of allocating a process for the received packet to the one or more processors, and a setting process of setting for the schedule process so that the process for the received packet is allocated to the distribution destination processor of the received packet determined based on the correspondence.

### CROSS-REFERENCE TO RELATED APPLICATION

This application is based upon and claims the benefit of priority of the prior Japanese Patent Application No. 2015-041125, filed on Mar. 3, 2015, the entire contents of which are incorporated herein by reference.

### FIELD

The embodiments discussed herein are related to a communication apparatus and a processor allocation method for the same.

### BACKGROUND

In recent years, network interface cards (NICs) supporting high-speed communication such as 10 gigabit/40 gigabit Ethernet (registered trademark) have also been used in a personal computer (PC) server field.

On the other hand, the number of operation clocks of a central processing unit (CPU) is limited to approximately 3.0 GHz. By providing a plurality of “cores” (also called “CPU cores”) in a CPU to increase the number of execution entities capable of performing parallel processing, performance tends to be improved. An environment where a CPU includes a plurality of cores is called a multi-core environment. A method of distributing the transmission/reception of a packet among a plurality of CPU cores to obtain high communication performance in a multi-core environment has been developed, and is employed in various communication apparatuses.

Examples of the method of distributing the transmission/reception of a packet among a plurality of CPU cores include Receive Side Scaling (RSS). RSS is a technique for distributing packet receive processing among a plurality of CPUs by providing a plurality of receive queues in an NIC and causing the receive queues to generate respective interrupts. Upon receiving packets from a network, an NIC distributes the packets among the receive queues in accordance with a distribution rule. As a result, packet receive processing of a kernel is performed in parallel in a plurality of CPUs.

A receive queue that is the distribution destination of a packet is typically determined based on a flow to which the packet belongs. A receive queue is determined in accordance with, for example, a hash value based on a transmission source IP (Internet Protocol) address, a transmission source port number, a destination IP address, and a destination port number. Packets belonging to the same flow are therefore distributed to the same receive queue and are processed by the same CPU.

However, in a case where a CPU that is a packet distribution destination and a CPU where a packet destination process operates are different from each other, the simple distribution of packets among a plurality of CPUs performed in RSS causes the following problem. That is, overhead such as interrupt processing between CPUs performed for the transfer of processing between the CPUs and an access to a main memory performed for the synchronization of cache content between CPUs occurs.

In order to make a CPU that is a packet distribution destination and a CPU where a destination process operates conform to each other, the following methods are considered. A first method is a method controlling a CPU that is a packet distribution destination for conformance to a CPU where a destination process operates. A second method is a method controlling a CPU where a destination process operates for conformance to a CPU that is a packet distribution destination.

Examples of a technique employing the first method include Receive Flow Steering (RFS) and Intel Flow Director. This technique is a technique for rewriting a distribution rule for the conformity between a CPU where a destination process operates and a CPU that is a packet distribution destination. However, the first method has the following problem.

In the first method, for each control target flow, a distribution rule is created. In a case where the number of flows increases, the capacity of a table may be therefore enormously increased. Furthermore, in the first method, in a case where a CPU where a destination process operates is changed by a scheduler (schedule process) of an OS, packets may be received by the destination process in an order different from an order in which they have reached an apparatus.

On the other hand, examples of a technique employing the second method include a parallelized proxy apparatus capable of performing kernel processing and proxy processing related to a certain session in the same CPU core (see, for example, International Publication Pamphlet No. WO 2011/096307). As disclosed in International Publication Pamphlet No. WO 2011/096307, a multi-core CPU including a plurality of CPU cores, an extended listen socket having a plurality of queues corresponding to the CPU cores, a plurality of kernel threads corresponding to the CPU cores, and a plurality of proxy threads corresponding to the CPU cores are provided. Each kernel thread performs processing for receiving a client-side connection establishment request packet allocated to a CPU core where the kernel thread operates and registers an establishment waiting socket in a queue corresponding to the CPU core. Each proxy thread refers to a queue corresponding to a CPU core where the proxy thread operates and establishes a first connection when an establishment waiting socket is registered in the queue.

However, the technique disclosed in International Publication Pamphlet No. WO 2011/096307 employs unique specifications in which, in a connection establishment procedure, each process receives only a connection establishment socket processed in a CPU core where the process operates. In a case where this technique is applied to existing software, it is desired that the software be modified. Accordingly, this technique can be applied to only software from which a source code can be obtained.

It is an object of an embodiment of the present disclosure to provide a technique for making a processor that is a distribution destination of a packet and a processor where a process for processing the packet operates conform to each other without the modification of existing software.

### SUMMARY

According to an aspect of the embodiments, a communication apparatus includes: a memory; processors coupled to the memory; and a network interface card configured to distribute a received packet to one of the processors in accordance with a distribution rule, wherein one or more processors of the processors execute: a management process of managing a correspondence between a flow to which the received packet belongs and a distribution destination processor of the processors of the received packet determined in accordance with the distribution rule, a schedule process of allocating a process for the received packet to the one or more processors, and a setting process of setting for the schedule process so that the process for the received packet is allocated to the distribution destination processor of the received packet determined based on the correspondence.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary network configuration according to an embodiment of the present disclosure;

FIG. 2 is a schematic functional diagram of a server (communication apparatus) according to a first embodiment of the present disclosure;

FIG. 3 is a schematic functional diagram of a server (communication apparatus) according to a second embodiment of the present disclosure;

FIG. 4 is a diagram illustrating an example of a packet (frame) that a server receives from a client;

FIG. 5 is a diagram illustrating an exemplary data structure (distribution rule) of a packet distribution table;

FIG. 6 is a diagram illustrating a data structure of a flow/CPU correspondence table;

FIG. 7 is a diagram describing an exemplary operation of a process determination section;

FIG. 8 is a diagram describing an example of CPU allocation setting processing;

FIG. 9 is a flowchart illustrating an exemplary operation of a server according to the second embodiment;

FIG. 10 is a flowchart illustrating an exemplary operation of a server that is a first modification of the second embodiment;

FIG. 11 is a flowchart illustrating an exemplary operation of a server that is a second modification of the second embodiment;

FIG. 12 is a flowchart illustrating an exemplary operation of a server that is a third modification of the second embodiment;

FIG. 13 is a flowchart illustrating an exemplary operation of a server that is a fourth modification of the second embodiment; and

FIG. 14 is a flowchart illustrating an exemplary operation at the time of a change in a distribution rule according to the second embodiment.

### DESCRIPTION OF EMBODIMENTS

A communication apparatus according to an embodiment of the present disclosure will be described below with reference to the accompanying drawings. A configuration employed in an embodiment of the present disclosure is described by way of example, and another configuration may be therefore employed.

In a communication apparatus according to an embodiment of the present disclosure which is provided with a plurality of CPUs, a CPU that is a distribution destination of a packet and a CPU where a process for processing the packet operates are made to conform to each other without the modification of existing software.

In an embodiment of the present disclosure, the operation of a scheduler for performing process allocation (scheduling) is controlled so that a destination process of a packet (that is, a process for processing the packet) is allocated to a CPU to which the packet is distributed. In this embodiment, a scheduler is one of functions of an operating system (OS) that is an example of existing software provided in a communication apparatus.

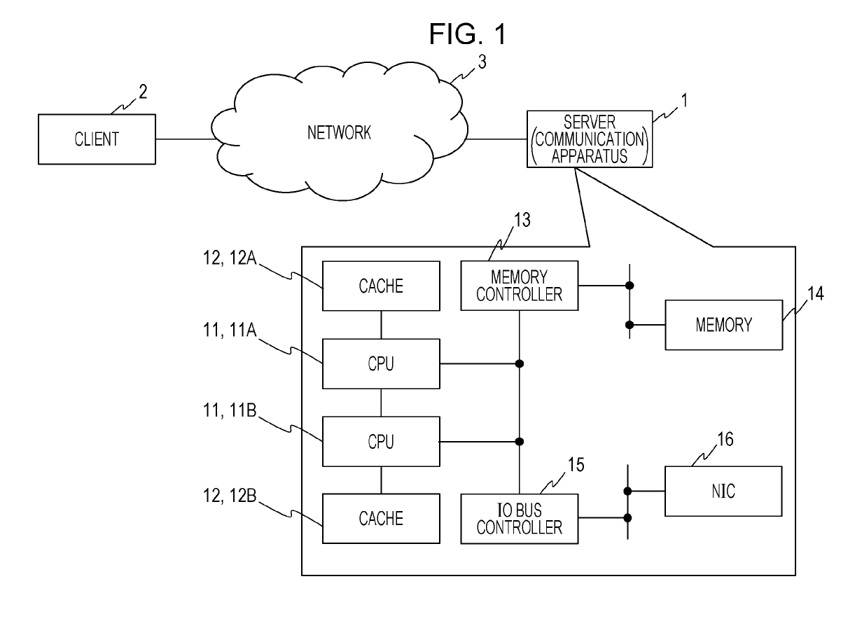

FIG. 1 is a diagram illustrating an exemplary network configuration according to an embodiment of the present disclosure. Referring to FIG. 1, a network system includes a server 1 and a client 2 that communicates with the server 1 via a network 3. The server 1 transmits information to the client 2 or provides service for the client 2. The server 1 may be a data center. The network 3 is, for example, the Internet, an intranet, or another IP network.

The server 1 is an example of a “communication apparatus”. Here, a communication apparatus is not limited to the server 1, and may be the client 2. A communication apparatus is, for example, an information processing apparatus (computer) having a data communication function such as a personal computer (PC), a server machine, a smartphone, or a Personal Digital Assistant (PDA) or a group of information processing apparatuses. A communication apparatus is not limited to a terminal apparatus such as the client 2 or the server 1, and may be an intermediary apparatus such as a router or a layer 3 switch.

The server 1 includes a plurality of CPUs 11 and a cache memories 12 used by the CPUs 11. In the exemplary configuration illustrated in FIG. 1, two CPUs, a CPU 11A and a CPU 11B, a cache memory 12A used by the CPU 11A, and a cache memory 12B used by the CPU 11B are illustrated.

The number of the CPUs 11 may be three or more. In the exemplary configuration illustrated in FIG. 1, a plurality of CPUs, the CPUs 11, are provided. However, instead of the CPUs 11A and 11B, a multi-core CPU (including a plurality of CPU cores) may be employed. Here, “a plurality of CPUs” are used as a concept including a CPU provided with a plurality of CPU cores.

The CPU 11A and the CPU 11B are connected to a memory 14 via a memory controller 13. The memory 14 includes a volatile storage medium and a nonvolatile storage medium. The volatile storage medium is, for example, a Random Access Memory (RAM). A RAM is used as a work area for the CPU 11, a program decompression area, and a data storage area. A nonvolatile storage medium includes at least one of a Read-Only Memory (ROM), a hard disk drive (HDD), a solid state drive (SSD), an electrically erasable programmable read-only memory (EEPROM), and a flash memory. A nonvolatile storage medium stores an OS, various application programs, and data used at the time of the execution of a program. Each of the cache memories 12 (cache memories 12A and 12B) is used as a storage area for temporarily storing data read from the memory 14.

Each of the CPUs 11 (the CPUs 11A and 11B) is connected to an NIC 16 via an input-output (TO) bus controller 15. The NIC 16 is an interface circuit for transmitting/receiving a packet to/from the client 2 via the network 3. As the NIC 16, for example, a local area network (LAN) card can be employed.

Each of the CPU 11A and the CPU 11B performs predetermined processing at the time of execution of an OS and an application program. For example, at the time of execution of a program, each of the CPUs 11A and 11B generates a process for processing a packet received from the client 2 (communication process). The communication process performs predetermined processing upon a packet.

In the server 1, packets received from the client 2 are processed by the CPUs 11A and 11B in parallel in a distributed manner. The NIC 16 therefore distributes the packets between the CPUs 11A and 11B.

A CPU where a process for processing a packet operates is selected from between the CPUs 11A and 11B. The allocation of a CPU to the process for processing a packet is performed by a scheduler (schedule process) 102 that is one of functions of an OS.

The memory 14 and the cache memory 12 are examples of a “memory” and a “computer-readable storage medium. The CPU 11 is an example of a “processor”. A “processor” is used as a concept including a CPU core.

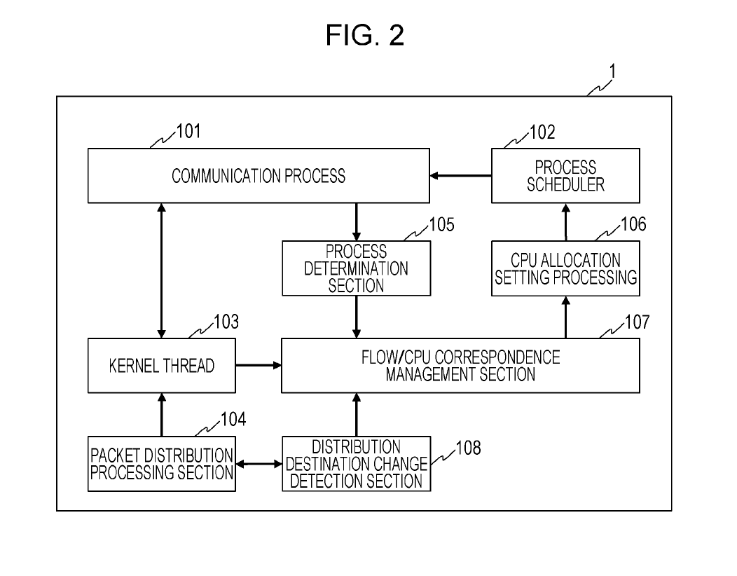

FIG. 2 is a schematic functional diagram of the server 1 (communication apparatus) according to the first embodiment. The server 1 includes a communication process 101, the process scheduler 102, a kernel thread 103, a packet distribution processing section 104, a process determination section 105, a CPU allocation setting processing 106, a flow/CPU correspondence management section 107, and a distribution destination change detection section 108.

The communication process 101 is an example of a “process for processing a received packet”. The scheduler 102 is an example of a “scheduler”. The kernel thread 103 is an example of a “transfer section for transferring a distributed packet to a process for processing a received packet”. The packet distribution processing section 104 is an example of a “distribution section”. The process determination section 105 is an example of a “determination section”. The CPU allocation setting processing 106 is an example of “setting processing”. The flow/CPU correspondence management section 107 is an example of a “management section”. The distribution destination change detection section 108 is an example of a “detection section”.

The packet distribution processing section 104 is provided in the NIC 16. The scheduler 102 and the kernel thread 103 are functions obtained when the CPU 11 executes an OS. The communication process 101, the process determination section 105, the CPU allocation setting processing 106, the flow/CPU correspondence management section 107, and the distribution destination change detection section 108 are functions of the CPU 11 obtained when the CPU 11 executes a program. The communication process 101 and the kernel thread 103 operate on the CPUs 11 (the CPUs 11A and 11B). The scheduler 102, the process determination section 105, the CPU allocation setting processing 106, the flow/CPU correspondence management section 107, and the distribution destination change detection section 108 can operate in at least one of the CPUs 11A and 11B.

The communication process 101 (hereinafter also referred to as the “process 101”) performs data communication with a communication opposite apparatus (the client 2 in an embodiment of the present disclosure). The kernel thread 103 performs protocol processing upon a packet received from a communication opposite apparatus and transfers the processed packet to the process 101.

The packet distribution processing section 104 (hereinafter also referred to as the “distribution processing section 104”) distributes packets (packet processing) received from a communication opposite apparatus between the CPUs 11A and 11B in accordance with a predetermined distribution algorithm and a distribution rule.

The flow/CPU correspondence management section 107 (hereinafter also referred to as the “management section 107”) manages information about the correspondence between a flow to which a received packet belongs and a CPU that is a distribution destination of a packet belonging to the flow (flow/CPU correspondence information).

The process determination section 105 (hereinafter also referred to as the “determination section 105”) determines whether a destination process is a process for performing external data communication (the process 101). The CPU allocation setting processing 106 (hereinafter also referred to as the “setting processing 106”) refers to the flow/CPU correspondence information managed by the management section 107 to obtain information about a CPU corresponding to a flow processed by the process 101. The setting processing 106 sets the scheduler 102 so that a CPU (the CPU 11A or 11B) specified by the information is allocated to the communication process 101.

The distribution destination change detection section 108 (hereinafter also referred to as the “detection section 108”) detects that the distribution processing section 104 has changed a packet distribution destination and notifies the management section 107 of the detected change. The management section 107 updates the correspondence based on information indicating the changed packet distribution destination notified by the detection section 108. The scheduler 102 allocates the CPU 11 designated by the setting processing 106 to the process 101.

The server 1 makes a CPU where a destination process for a received packet operates conform to a CPU that is the distribution destination of the packet using the following procedures.

(First Procedure) The server 1 monitors a packet received from a network (the network 3). A monitoring target packet may be a packet belonging to a flow of an established connection or a packet for the establishment of a new connection. A connection is, for example, a transmission control protocol (TCP) session or a stream control transmission protocol (SCTP) session. In an embodiment of the present disclosure, a TCP session is employed.

(Second Procedure) Information about the correspondence between a CPU to which the monitoring target packet is to be distributed by the distribution processing section 104 and identification information of a flow to which the monitoring target packet belongs is managed by the management section 107 as correspondence information. The flow identification information includes, for example, four pieces of information, a transmission source IP address, a transmission source port number, a destination IP address, and a destination port number. Alternatively, the flow identification information may be a hash value calculated based on these four pieces of information.

(Third Procedure) In a case where the scheduler 102 allocates a CPU to a process, the determination section 105 determines whether a target process is the process 101 for performing external data communication. In the third procedure, in a case where the target process is determined to be the process 101, the setting processing 106 acquires, from the correspondence information, information about a CPU that is a distribution destination of a packet belonging to a flow processed by the process 101. At that time, it is determined that the target process is not the process 101, a fourth and subsequent procedures are not performed.

(Fourth Procedure) The setting processing 106 designates a CPU that is a packet distribution destination as a CPU to which the process 101 is to be allocated by the scheduler 102. The scheduler 102 allocates the designated CPU to the process 101.

(Fifth Procedure) In a case where a CPU that is the distribution destination of a received packet is changed, the detection section 108 updates the correspondence information (information about the correspondence between a flow to which the packet belongs and a distribution destination CPU) managed by the management section 107.

Thus, according to the first embodiment, the setting processing 106 makes an instruction for the scheduler 102 so that a CPU allocated to the process 101 for communicating with a communication opposite apparatus conforms to a CPU determined through distribution processing performed by the distribution processing section 104. It is therefore possible to make a CPU where a packet destination process operates conform to a CPU that is a packet distribution destination without changing the implementation of a process (without making a modification to existing software).

According to the first embodiment, it is possible to reduce the occurrence of the above-described problems (a delay due to the occurrence of overhead and the change in the order of packets) when RSS or the first method is employed. Furthermore, according to the first embodiment, since a modification is not made to existing software, the range of application of the software can be extended as compared with a case where the technique disclosed in International Publication Pamphlet No. WO 2011/096307 is used.

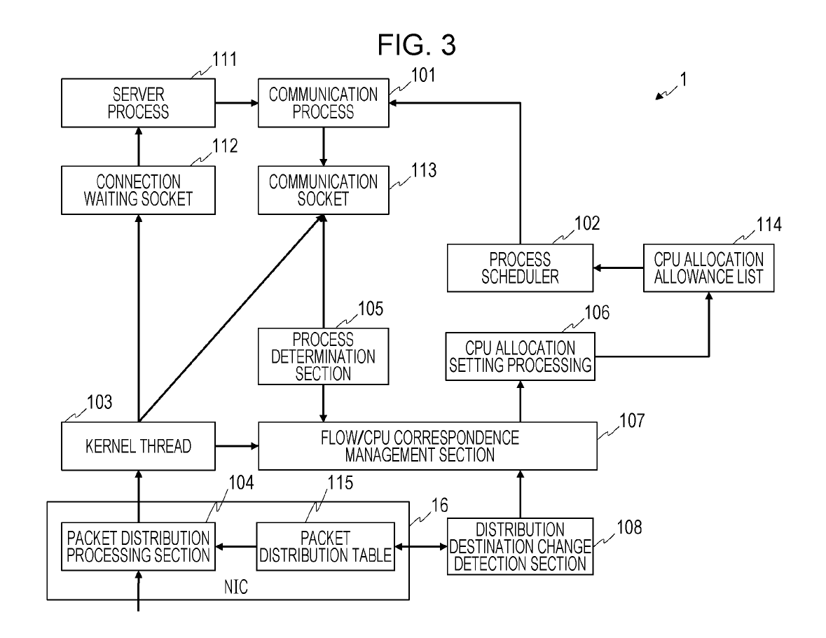

FIG. 3 is a schematic functional diagram of the server 1 (communication apparatus) according to the second embodiment of the present disclosure. Referring to FIG. 3, the server 1 includes the process 101, the scheduler 102, the kernel thread 103, the distribution processing section 104, the determination section 105, the setting processing 106, the management section 107, and the detection section 108 which are illustrated in FIG. 2. The server 1 further includes a server process (connection waiting process) 111, a connection waiting socket 112, a communication socket 113, a CPU allocation allowance list 114, and a packet distribution table 115.

The server process 111, the connection waiting socket 112, and the communication socket 113 are generated by the CPU 11A or 11B. The CPU allocation allowance list 114 is generated in the memory 14 or the cache memory 12. The packet distribution table 115 is stored in a memory (storage device) in the NIC 16.

Upon receiving a connection request from a communication opposite apparatus (for example, the client 2) via the connection waiting socket 112, the server process 111 generates a data communication socket (the communication socket 113) used for communication with the communication opposite apparatus and the communication process 101.

The communication process 101 performs data communication with a communication opposite apparatus, with which a connection has been established, via the communication socket 113. The kernel thread 103 performs protocol processing upon a packet received from the distribution processing section 104. At that time, in a case where a connection with a communication opposite apparatus is not established, the kernel thread 103 transfers the packet that has been subjected to the protocol processing to the connection waiting socket 112. On the other hand, in a case where a connection with a communication opposite apparatus is established (the communication socket 113 has already been generated), the kernel thread 103 transfers the packet that has been subjected to the protocol processing to the communication socket 113.

The connection waiting socket 112 is an interface dedicated for receiving a connection establishment packet (for example, an SYN packet in TCP) from a communication opposite apparatus. When a connection establishment packet reaches the connection waiting socket 112, the connection waiting socket 112 notifies the server process 111 of the arrival of the connection establishment packet.

The communication socket 113 is an interface used for exchange of a packet between an OS kernel and the process 101. The NIC 16 receives from the network 3 a packet transmitted to the server 1. In addition, the NIC 16 transmits a packet from the server 1 to the network 3.

The distribution processing section 104 distributes a packet received from the network 3 to the CPU 11 (the CPU 11A or 11B) in accordance with a distribution rule stored in the packet distribution table 115. The distribution processing section 104 transfers a packet to the kernel thread 103 operating in the CPU 11 that is a distribution destination.

The packet distribution table 115 (hereinafter also referred to as the “table 115”) stores a distribution rule used to determine the CPU 11 that is a packet distribution destination. The distribution rule includes, for example, a hash value based on packet header information and information about a CPU that is a distribution destination corresponding to the hash value. As the header information, for example, four pieces of information, a transmission source IP address, a transmission source port number, a destination IP address, and a transmission destination port number, can be used.

The management section 107 manages correspondence information indicating the correspondence between a flow to which a received packet belongs and a CPU that is a distribution destination of a packet belonging to the flow. The determination section 105 determines whether a process to which the scheduler 102 allocates the CPU 11 is the process 101 for performing external communication. More specifically, for example, the determination can be performed by determining whether information about the communication socket 113 is linked to attribute information of the process.

In a case where the determination section 105 determines that the process is the process 101 for performing external data communication, the setting processing 106 refers to the correspondence information to acquire information indicating the CPU 11 corresponding to a flow processed by the process 101. The setting processing 106 changes the CPU allocation allowance list 114 with the acquired information indicating the CPU 11.

The CPU allocation allowance list 114 (hereinafter also referred to as the “list 114”) is a list of the CPUs 11 that the scheduler 102 can allocate to a predetermined process. The list 114 is provided for each process. The predetermined process includes the process 101.

The detection section 108 detects that the CPU 11 that is a distribution destination of a packet corresponding to a certain flow has been changed. For example, the detection section 108 monitors a section for changing a distribution destination (for example, a command input operation performed by an administrator (operator)) and detects that a distribution destination has been changed by the command input operation. The detection section 108 notifies the management section 107 of details of the change.

The scheduler 102 allocates the CPU 11 to a process. The scheduler 102 selects an allocation target CPU from among the CPUs 11 registered in the list 114.

### Exemplary Operation

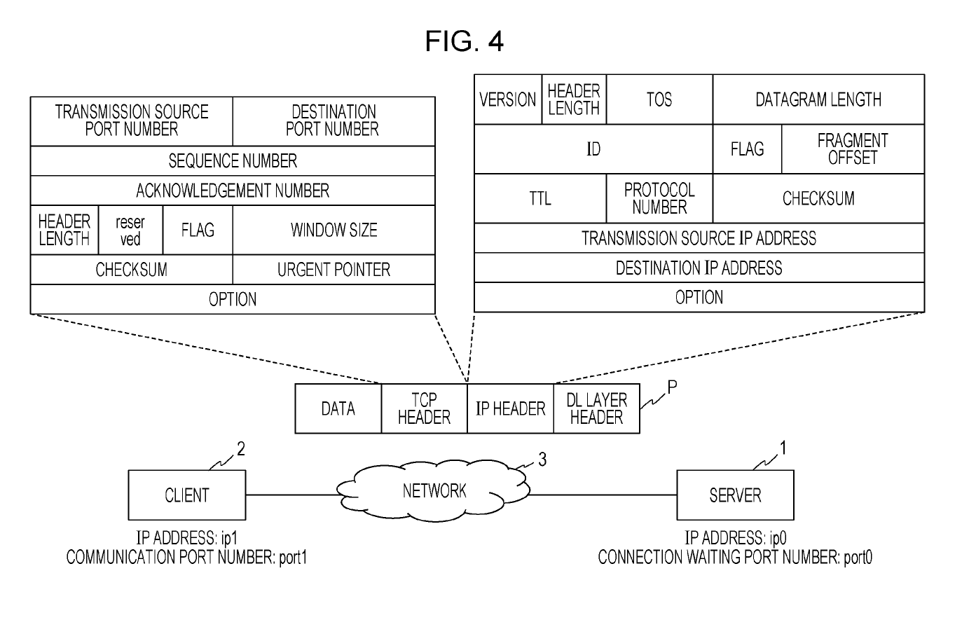

Next, an exemplary operation according to the second embodiment will be described. FIG. 4 is a diagram illustrating an example of a packet (frame) that the server 1 receives from the client 2. As illustrated in FIG. 4, a packet P includes user data (data: payload) transmitted from the client 2 to the server 1, a TCP header, an IP header, and a data link (DL) layer header.

The TCP header includes a transmission source port number and a destination port number. The IP header includes a transmission source IP address and a destination IP address. As the transmission source port number, a communication port number “port1” of the client 2 is set. As the destination port number, a connection waiting port number “port0” of the server 1 is set. As the transmission source IP address, an IP address “ip1” of the client 2 is set. As the destination IP address, an IP address “ip0” of the server 1 is set.

The server process 111 (connection waiting process) operating in the server 1 calls a socket function to generate the connection waiting socket 112 for receiving a connection request from an external apparatus (the client 2). A connection waiting IP address of the connection waiting socket 112 is “ip0”, and a connection waiting port number of the connection waiting socket 112 is “port0” (see FIG. 4).

Furthermore, the server process 111 calls a listen function using the connection waiting socket 112 as an argument to be capable of receiving a connection request for the connection waiting IP address “ip0” and the connection waiting port number “port0”.

The distribution processing section 104 in the NIC 16 extracts four pieces of information, a destination IP address, a destination port number, a transmission source IP address, and a transmission source port number, included in the header of a packet received by the NIC 16 as flow identification information. The flow identification information is an example of “information indicating a flow”. The distribution processing section 104 calculates a hash value based on the flow identification information. Furthermore, the distribution processing section 104 distributes received packets among the CPUs 11 in accordance with the distribution rule stored in the packet distribution table 115.

As an algorithm for calculating a hash value, for example, a hash function called “Toeplitz Hash” can be used. However, a calculation algorithm (hash function) is not limited to “Toeplitz Hash”, and another calculation algorithm may be employed.

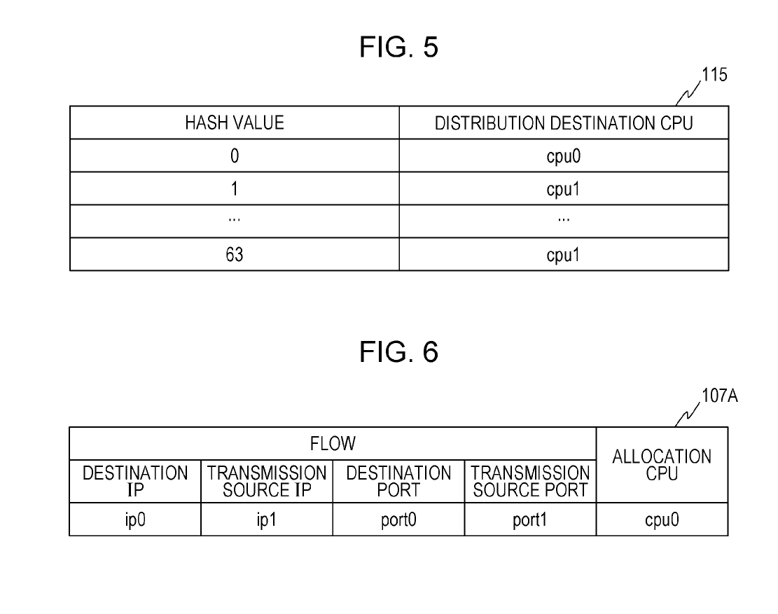

FIG. 5 is a diagram illustrating an exemplary data structure (distribution rule) of the packet distribution table 115. As illustrated in FIG. 5, the table 115 stores pieces of information indicating distribution destination CPUs corresponding to hash values. For example, a packet distribution destination CPU corresponding to a hash value “0” is the CPU 11A specified by an identifier “cpu0”, and a packet distribution destination CPU corresponding to a hash value “1” is the CPU 11B specified by an identifier “cpu1”.

Thus, in the example illustrated in FIG. 5, a packet having an even hash value is distributed to the cpu0 (the CPU 11A), and a packet having an odd hash value is distributed to the cpu1 (the CPU 11B). This distribution rule does not necessarily have to be set, and another distribution rule may be employed. In an exemplary operation, a distribution rule (registered details of the table 115) is set in advance by a command input operation performed by an administrator (operator).

In order to establish a connection to the server 1, the client 2 transmits a packet (called “connection establishment request packet”) for requesting a connection to a destination having the IP address “ip0” and the port number “port0”. The structure (format) of a connection establishment request packet is the same as that of the packet P illustrated in FIG. 4.

More specifically, in an IP header, the IP address “ip0” is set as a destination IP address and the port number “port0” is set as a destination port number. The IP address “ip1” assigned to the client 2 is set as the transmission source IP address. A port number “port1” that is not used in the client 2 is set se the transmission source port number. In a flag field in the TCP header, an SYN bit is set to “1”. The setting of the SYN bit to “1” is that the packet is a connection establishment request packet.

When the NIC 16 receives a connection establishment request packet from the network 3, the distribution processing section 104 acquires four pieces of information from the header of the connection establishment request packet as the flow identification information and calculates a hash value for the four pieces of information. The four pieces of information are the destination IP address “ip0”, the destination port number “port0”, the transmission source IP address “ip1”, and the transmission source port number “port1”.

At that time, it is assumed that a result of calculation of a hash value is “4”. The distribution processing section 104 distributes a connection establishment request packet to the CPU 11A (cpu0) in accordance with the distribution rule (FIG. 5) represented by the table 115.

Upon receiving the connection establishment request packet from the distribution processing section 104, the kernel thread 103 operating in the CPU 11A (cpu0) establishes a connection with the client 2 in accordance with the following procedure called 3way-handshake.

(1) In a case where an SYN bit is set to “1” in the TCP header of the packet, the kernel thread 103 checks whether a connection request for a destination IP address and a destination port number included in the packet has been received (whether there is the connection waiting socket 112). At that time, in a case where such a connection request has been received (there is the connection waiting socket 112), the kernel thread 103 sends a so-called “SYN+ACK packet” back to the client 2.

(2) The kernel thread 103 receives a response (ACK packet) to the SYN+ACK packet from the client 2. By the above-described 3way-handshake, a connection with the client 2 is established for the flow of a packet specified with the above-described four pieces of information. The kernel thread 103 generates a socket (the communication socket 113) for data communication with the client 2 and transfers the socket to the server process 111 (connection waiting process) via the connection waiting socket 112.

(3) Upon receiving the communication socket 113 from the kernel thread 103, the server process 111 (connection waiting process) generates the communication process 101 and transfers the communication socket 113 to the communication process 101. From this point forward, the communication process 101 performs data communication with the client 2 via the communication socket 113. That is, a packet of the flow received by the kernel thread 103 is transferred to the communication socket 113, and is subjected to predetermined processing in the communication process 101.

The management section 107 manages the correspondence between a packet flow and a distribution destination CPU of a packet belonging to the flow. The management section 107 has a flow/CPU correspondence table 107A (hereinafter also referred to as the “table 107A”).

FIG. 6 is a diagram illustrating a data structure of the flow/CPU correspondence table 107A. Referring to FIG. 6, the table 107A stores information about the CPU 11 to which the communication process 101 for processing a packet belonging to a flow specified by the flow identification information is allocated. The table 107A is stored in, for example, the memory 14.

For example, as the flow identification information, four pieces of information (“ip0”, “ip1”, “port0”, and “port1”), a destination IP address, a destination port number, a transmission source IP address, and a transmission source port number, are stored. In addition, as a CPU where the communication process 101 for processing a packet belonging to a flow operates, the identifier (“cpu0”) of the CPU 11 that is the same as the distribution destination CPU in the NIC 16 is stored. The identifier of the CPU 11 is an example of “information indicating a processor”.

For example, the correspondence registered in the table 107A can be set in advance by a command input operation performed by an administrator. For example, in synchronization with setting of a distribution rule for the NIC 16 (registration of the distribution rule in the table 115), the correspondence is registered in the table 107A. However, another setting method may be employed.

The scheduler 102 performs process scheduling at a predetermined time and allocates the CPU 11 to a process. The determination section 105 checks whether an allocation target process is a process (the communication process 101) for performing data communication.

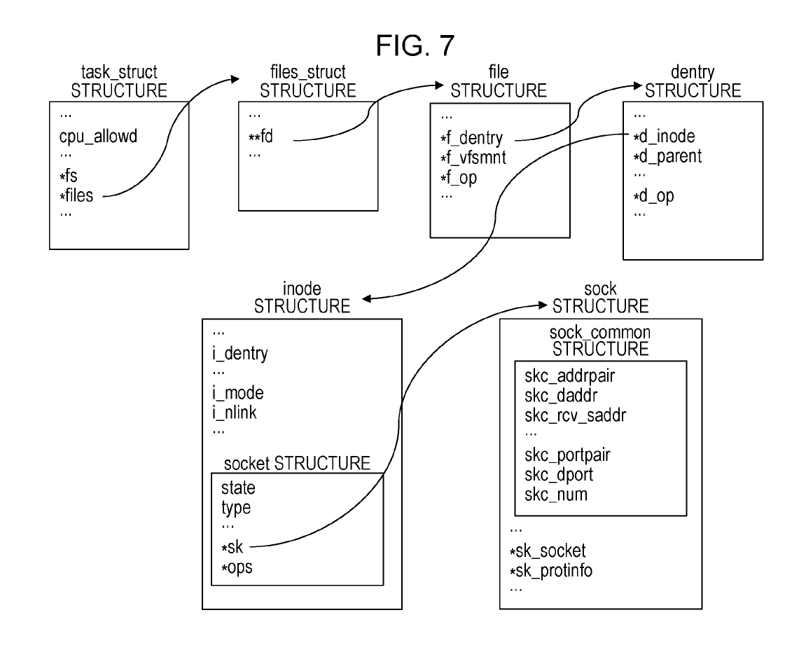

For example, checking can be performed as follows. An exemplary case where an OS is “Linux (registered trademark)” will be described. FIG. 7 is a diagram describing an exemplary operation of the process determination section 105. Information to be described below is stored in, for example, the memory 14.

(1) The determination section 105 traces information (a files struct structure) about a file in which a process opens from process information (a task struct structure) used for management of process information. Subsequently, the determination section 105 traces file descriptor information (a file structure) in the file information, directory entry information (a dentry structure) in the descriptor information, and i-node information (an inode structure).

(2) The i-node information includes mode information (i_mode). In a case where the value of the mode information is a value (0140000) indicating a socket file, the determination section 105 determines that the process is the communication process 101.

(3) In a case where it is determined that an allocation target process is the communication process 101, the determination section 105 acquires flow identification information processed by the communication process 101 using the following procedure. That is, socket information (a socket structure) and INET information (a sock structure) are traced from the i-node information. The socket information includes a socket common structure. The determination section 105 acquires a destination IP address (upper 4 bytes of skc_addrpair) and a transmission source IP address (lower 4 bytes of skc_addrpair) in the socket common structure. Furthermore, the determination section 105 acquires a destination port number (upper 4 bytes of skc_portpair) and a transmission source port number (lower 4 bytes of skc_portpair).

In the procedures (1) and (2), the determination section 105 determines that a process to which the scheduler 102 allocates the CPU 11 is the communication process 101. In the procedure (3), the determination section 105 acquires the flow identification information and transfers the flow identification information to the management section 107.

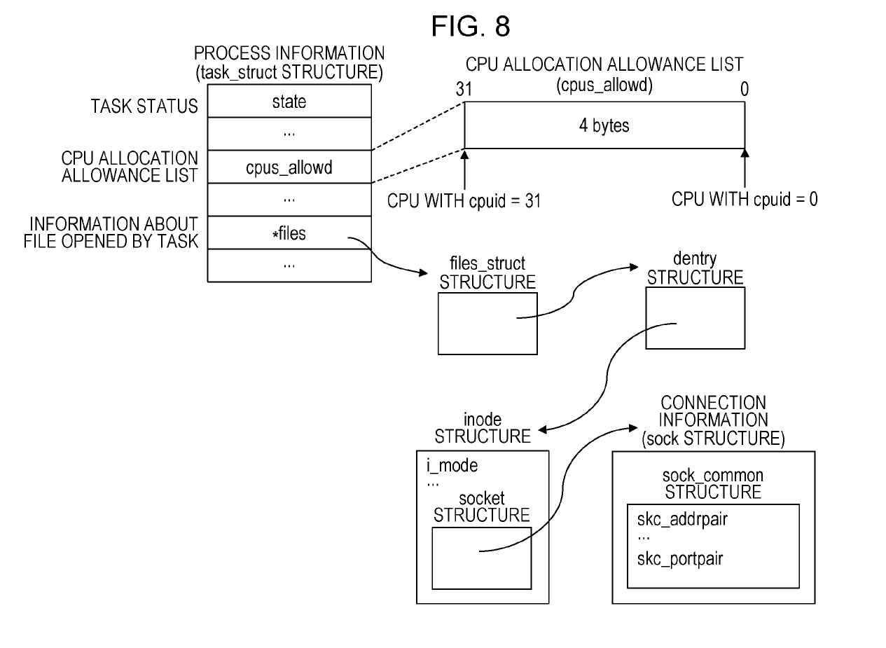

The management section 107 reads “cpu0”, which is identification information of an allocation CPU of a packet belonging to a flow specified with the flow identification information, from the table 107A and notifies the setting processing 106 of it. The setting processing 106 performs the following processing. FIG. 8 is a diagram describing an exemplary operation of the CPU allocation setting processing 106.

The process information (a task struct structure) includes a CPU allocation allowance list (cpu_allowd). This CPU allocation allowance list is the list 114. The list 114 has the size of 31 bits, and CPUs (“cpu0” to “cpu31”) are assigned to these bits in order from the least significant bit. In this embodiment, CPUs that are actually allocated and used are the CPU 11A (“cpu0”) and the CPU 11B (“cpu1”) in the server 1.

The setting processing 106 sets the least significant bit indicating “cpu0” in the list 114 to “1”, and the remaining bits are set to “0”. Here, “1” indicates allocation allowable, and “0” indicates allocation unallowable. As a result, only “cpu0” indicating a distribution destination CPU is registered in the list 114 as an allocation destination of the communication process 101.

In process scheduling, the scheduler 102 refers to the list 114 and allocates the CPU 11A (cpu0) to the communication process 101. Thus, the conformity between a distribution destination CPU and a CPU where the communication process 101 operates is provided.

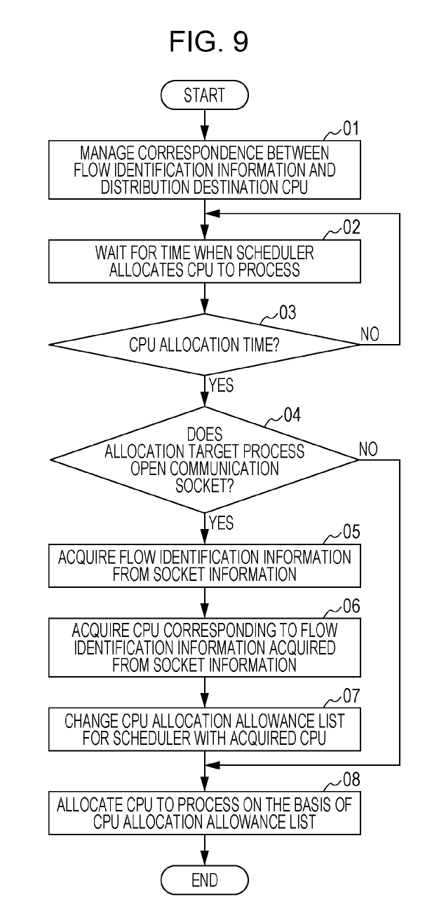

FIG. 9 is a flowchart illustrating an exemplary operation of the server 1 according to the second embodiment. In 01, the management section 107 stores the correspondence between flow identification information and a distribution destination CPU (allocation CPU) in the table 107A.

In 02 and 03, the scheduler 102 waits for a time when to allocate the CPU 11 to a process. When a time of allocating the CPU 11 to a process arrives (Yes in 03), the determination section 105 determines whether an allocation target process opens the communication socket 113 (that is, whether an allocation target process is the communication process 101) (04). At that time, when a process is not the communication process 101 (No in 04), the process proceeds to 08. On the other hand, when a process is the communication process 101 (Yes in 04), the process proceeds to 05.

In 05, the determination section 105 acquires flow identification information (a destination IP address, a destination port number, a transmission source IP address, and a transmission source port number) from socket information (a socket structure).

In 06, the management section 107 reads information about an allocation CPU corresponding to the flow identification information notified by the determination section 105 from the table 107A and transfers a result of the reading to the setting processing 106. In 07, the setting processing 106 sets the allocation CPU in the list 114.

In 08, the scheduler 102 allocates the communication process 101 to the allocation CPU (that is the same as the distribution destination CPU) based on the list 114. Thus, it is possible to make a packet distribution destination CPU and a CPU where the communication process 101 for processing a packet conform to each other.

In the above-described exemplary operation, the server process 111, the communication socket 113 generated by the kernel thread 103, and the communication process 101 are the same as existing processes. There is no modification made to a process scheduling operation of the scheduler 102 of an OS.

When an allocation target process is the communication process 101, details of the list 114 are merely rewritten with a CPU corresponding to a flow that is a processing target of the communication process 101. Accordingly, using an existing OS (the scheduler 102), it is possible to make a distribution destination CPU and a CPU to which the communication process 101 is allocated conform to each other and reduce the occurrence of an overhead in RSS and the occurrence of problems at the time of employment of the first and second methods.

### First Modification

The second embodiment can be modified as follows. In the first embodiment, the registration of information in the table 107A is performed by a command input operation. However, the management section 107 may analyze a packet received from the network 3, autonomously generate the correspondence between a flow and a CPU, and register the correspondence in the table 107A.

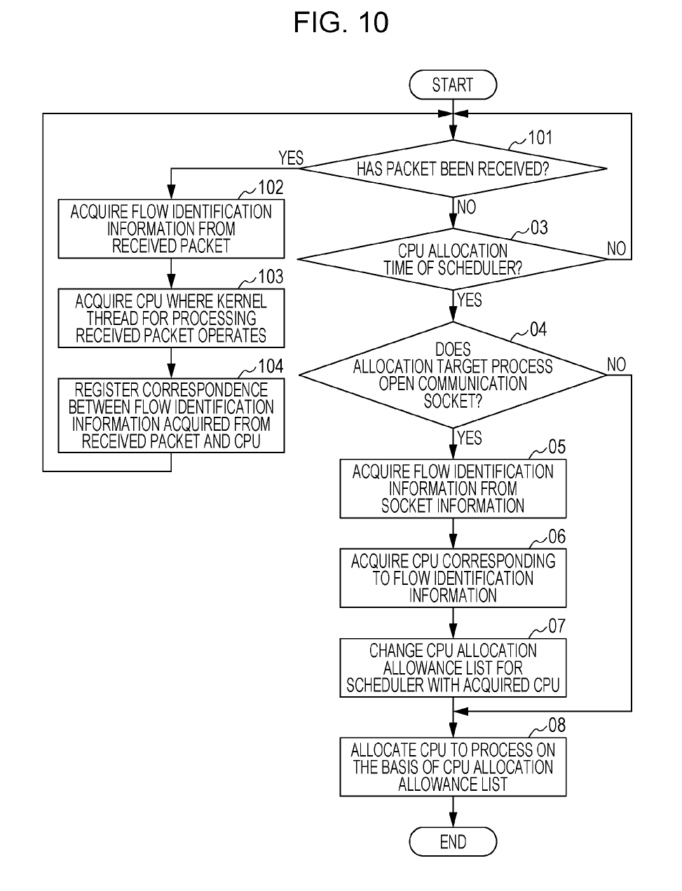

FIG. 10 is a flowchart illustrating an exemplary operation of the server 1 that is the first modification of the second embodiment. In 101, the management section 107 determines whether a packet has been received. At that time, in a case where a packet has not been received (No in 101), the process proceeds to 03. On the other hand, in a case where a packet has been received (Yes in 101), the process proceeds to 102. For example, the processing of 101 can be performed by determining whether the management section 107 has received a packet from the kernel thread 103.

In 102, the management section 107 acquires a destination IP address (“ip0”), a destination port number (“port0”), a transmission source IP address (“ip1”), and a transmission source port number (“port1”) from the header of the received packet as flow identification information of a flow to which the packet belongs.

In 103, the management section 107 checks which CPU 11 the kernel thread 103 for processing the received packet operates and determines that a result of the checking is a distribution destination CPU of the received packet. For example, this processing can be performed by causing the management section 107 to receive, from the kernel thread 103, the identifier of a CPU (distribution destination CPU) where the kernel thread 103 operates in addition to a packet. Alternatively, the management section 107 may ask the kernel thread 103 which CPU the kernel thread 103 operates.

In 104, the management section 107 registers the correspondence between the identifier of the distribution destination CPU and the flow identification information in the table 107A.

The process from 03 to 08 in FIG. 10 is the same as that (FIG. 9) described in the second embodiment, and the description thereof will be therefore omitted. In a case where a time of causing the scheduler 102 to perform the allocation of a CPU is not arrived (No in 03), the process returns to 101.

According to the first modification, since the table 107A is autonomously generated, a workload on an administrator can be reduced. In the process illustrated in FIG. 10, the management section 107 updates the table 107A each time a packet is received. At that time, in a case where the same flow identification information has already been registered in the table 107A, the management section 107 does not necessarily have to update the table 107A.

### Second Modification

In an operation that is the first modification, the correspondence is registered using a packet received after a connection between the server 1 and the client 2 has been established. On the other hand, in the second modification, the correspondence may be generated using a connection establishment packet (SYN packet) in 3way-handshake and be registered in the table 107A.

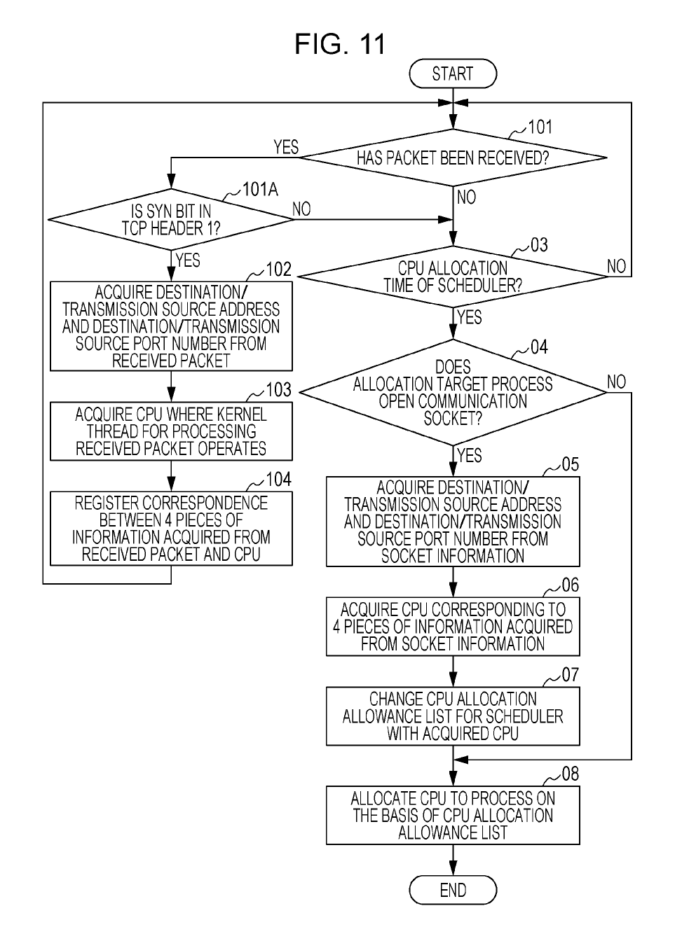

FIG. 11 is a flowchart illustrating an exemplary operation of the server 1 that is the second modification of the second embodiment. In the second modification, in a case where a packet is received (Yes in 101), the management section 107 determines whether the SYN bit in the TCP header of the packet is “1”. At that time, in a case where the SYN bit is “1” (Yes in 101A), the process proceeds to 102. In a case where the SYN bit is “0” (No in 101A), the process proceeds to 03.

The process illustrated in FIG. 11 is the same as that in the first modification (FIG. 10) except for the processing of 101A, and the description thereof will be therefore omitted. In the second modification, in synchronization with the establishment of a connection, the correspondence between flow identification information and a CPU can be registered in the table 107A.

### Third Modification

The management section 107 can obtain the correspondence between flow identification information and an allocation CPU using a hash value calculation algorithm (called “hash function”) of the NIC 16 and a distribution rule. A hash function and a distribution rule are examples of “information indicating a distribution rule”.

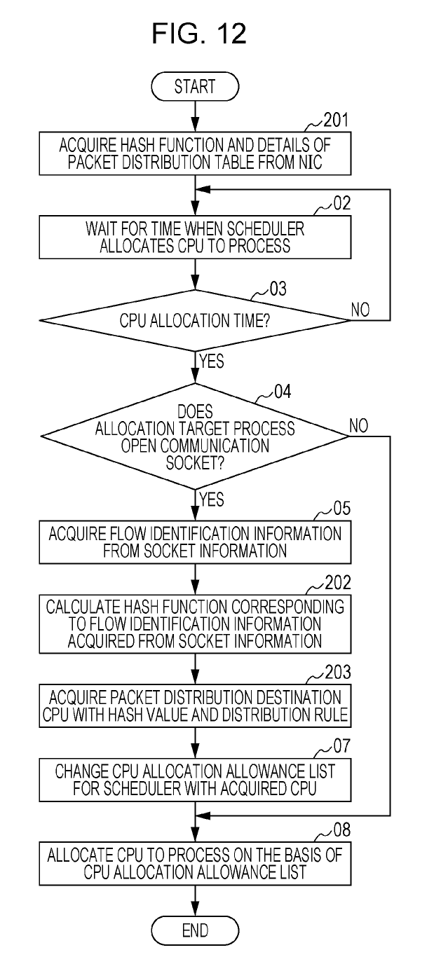

FIG. 12 is a flowchart illustrating an exemplary operation of the server 1 that is the third modification of the second embodiment. In 201, the management section 107 acquires a hash function and details of the packet distribution table 115 (a distribution rule) from the NIC 16. The management section 107 may acquire a hash function and a distribution rule through a manual operation such as a command input operation.

Subsequently, the process from 02 to 05, which is the same as that in the first embodiment, is performed, and the determination section 105 notifies the management section 107 of the flow identification information of a packet. The management section 107 calculates a hash value with the hash function and the flow identification information (202).

Subsequently, the management section 107 specifies a packet distribution destination CPU (allocation CPU) with the hash value and the distribution rule (203). After that, the process from 07 to 08, which is the same as that in the first embodiment, is performed, and the communication process 101 is allocated to the CPU 11 that is a distribution destination CPU.

In the third modification, without the table 107A, the management section 107 can specify an allocation CPU and the setting processing 106 can change a CPU to which the communication process 101 can be allocated in the list 114. Exchange of a packet between the management section 107 and the kernel thread 103 does not have to be performed. The identifier of a CPU specified by the processing of 203 and flow identification information may be registered in the table 107A, and the identifier of the CPU may be notified to the setting processing 106.

### Fourth Modification

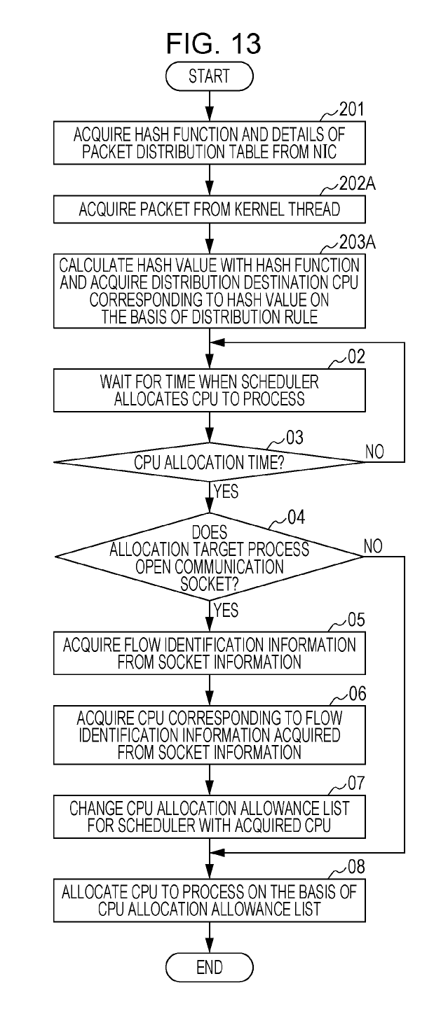

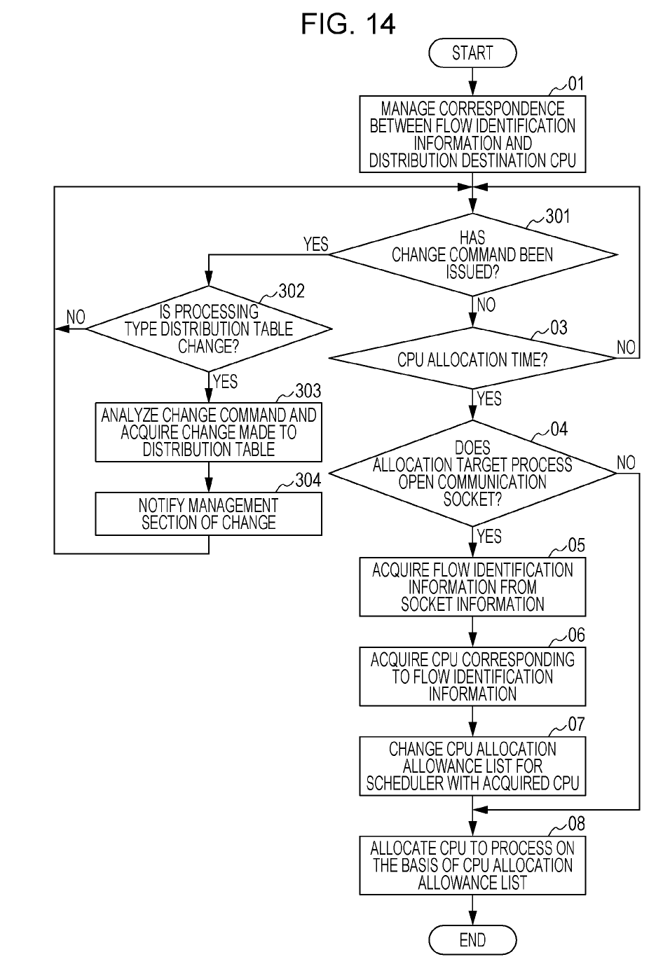

As the fourth modification of the second embodiment, an exemplary modification of the above-described third modification will be described. FIG. 13 is a flowchart illustrating an exemplary operation of the server 1 that is the fourth modification of the second embodiment. In 201 in FIG. 13, like in the third modification, the management section 107 acquires a hash function and details (a distribution rule) of the packet distribution table 115 from the NIC 16.

In 202A, the management section 107 acquires a packet from the kernel thread 103. In 203A, the management section 107 extracts flow identification information from the packet and calculates a hash value with the flow identification information and a hash function. Furthermore, the management section 107 acquires the identifier of the CPU 11 corresponding to the hash value with a distribution rule. Subsequently, the management section 107 associates the flow identification information and the identifier of the CPU 11 with each other and registers them in the table 107A.

After that, the process from 02 to 08 that is the same as that in the second embodiment is performed. Thus, the management section 107 can generate information (correspondence) registered in the table 107A using a packet received from the kernel thread 103, a hash function, and a distribution rule.

In the process illustrated in FIG. 13, the processing of 202 and the processing of 203 which are illustrated in FIG. 12 may be performed, and it may be determined whether the identifier of the CPU 11 registered in the table 107A and the identifier of the CPU 11 obtained by the processing of 203 conform to each other. In this case, after determining that they conform to each other, the identifier of the CPU 11 is notified to the setting processing 106.

### Detection of Change in Distribution Destination

An exemplary operation of the detection section 108 according to the second embodiment will be described. Upon detecting that information registered in the table 115 has been changed, the detection section 108 reflects the detected change in the correspondence managed by the management section 107.

For example, an exemplary case where an administrator inputs a distribution rule change command and a CPU to which a communication process for a certain flow is allocated is changed will be described.

For example, it is assumed that the distribution destination CPU of a flow identified by the destination IP address “ip0”, the destination port number “port0”, the transmission source IP address “ip1”, and the transmission source port number “port1” is changed to “cpu1” (CPU 11B).

FIG. 14 is a flowchart illustrating an exemplary operation at the time of a change in a distribution rule according to the second embodiment. In 01 in FIG. 14, it is assumed that the management section 107 manages the correspondence between flow identification information and a CPU.

In 301, the detection section 108 monitors the input (issue) of a change command. At that time, in a case where a change command has not been issued, the process proceeds to 03. In a case where a change command has been issued (Yes in 301), the detection section 108 obtains the change command and the process proceeds to 302.

In 302, the detection section 108 refers to information indicating a processing type included in the change command and determines whether the processing type is changing information registered in the table 115. At that time, in a case where the processing type is changing information registered in the table 115 (Yes in 302), the detection section 108 analyzes the change command to acquire a change in the table 115 (changed flow identification information and the identifier of a changed distribution destination CPU) included in the change command (303). In 304, the detection section 108 notifies the management section 107 of the change. The management section 107 changes information registered in the table 107A (that is, the value of an allocation CPU) to “cpu1” based on the notified change.

After that, the process from 03 to 08 that is the same as that in the second embodiment is performed. Thus, the detection section 108 can change a correspondence managed by the management section 107 in synchronization with the change in a distribution rule. The above-described embodiments may be combined as appropriate.

Additional note 1. A communication apparatus, comprising: a memory; processors coupled to the memory; and a network interface card configured to distribute a received packet to one of the processors in accordance with a distribution rule, wherein one or more processors of the processors execute: a management process of managing a correspondence between a flow to which the received packet belongs and a distribution destination processor of the processors of the received packet determined in accordance with the distribution rule, a schedule process of allocating a process for processing the received packet to the one or more processors, and a setting process of setting for the schedule process so that the process for processing the received packet is allocated to the distribution destination processor of the received packet determined based on the correspondence.

Additional note 2. The communication apparatus according to additional note 1, further comprising: a determination process of determining to acquire flow information indicating a flow to which the received packet belongs from information regarding the process for processing the received packet and supply the flow information to the management processing when determining that the process to be allocated to one of the processors is the process for the received packet, wherein the management process acquires information indicating a distribution destination processor of the processors corresponding to the flow information from the correspondence and supply the acquired information to the schedule process, and the setting process provides setting for the schedule process using the information indicating a distribution destination processor of the received packet.

Additional note 3. The communication apparatus according to additional note 1, wherein, while the management process extracts flow information from the received packet, the management process acquires information indicating the distribution destination processor from a transfer process of transferring the received packet distributed to the distribution destination processor by the network interface card to the process for processing the received packet, and stores the flow information and the information indicating the distribution destination processor as the correspondence.

Additional note 4. The communication apparatus according to additional note 3, wherein the received packet is a packet used for establishment of a connection between the communication apparatus and a communication opposite apparatus.

Additional note 5. The communication apparatus according to additional note 1, wherein the one or more processors store information indicating the distribution rule used by the network interface card, and supply, to the schedule process, information indicating the distribution destination processor acquired with the flow information indicating a flow to which the received packet belongs and the information indicating the distribution rule.

Additional note 6. The communication apparatus according to additional note 1, wherein the one or more processors change details of a list that is referred to by the schedule process and register the one or more processors to which the process for processing the received packet can be allocated by registering the distribution destination processor in the list.

Additional note 7. The communication apparatus according to additional note 1, wherein the one or more processors detect a change in the distribution rule used by the network interface card, detect a notification of information indicating a changed distribution rule to the management process, and update the correspondence with the information indicating the changed distribution rule.

Additional note 8. A processor allocation method for a communication apparatus including a memory and processors coupled to the memory, the method comprising: distributing a received packet to one of the processors in accordance with a distribution rule; performing management processing for managing a correspondence between a flow to which the received packet belongs and a distribution destination processor of the processors of the received packet determined in accordance with the distribution rule; and providing setting for a schedule process configured to allocate a process for processing the received packet to one of the processors so that the process for processing the received packet is allocated to the distribution destination processor of the received packet determined based on the correspondence.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication apparatus, comprising:
a memory;
processors coupled to the memory; and
a network interface card configured to distribute a received packet to one of the processors in accordance with a distribution rule, wherein one or more processors of the processors execute:
a management process of managing a correspondence between a flow to which the received packet belongs and a distribution destination processor of the processors of the received packet determined in accordance with the distribution rule,
a schedule process of allocating a process for processing the received packet to the one or more processors, and
a setting process of setting for the schedule process so that the process for processing the received packet is allocated to the distribution destination processor of the received packet determined based on the correspondence.

2. The communication apparatus according to claim 1, further comprising:
a determination process of determining to acquire flow information indicating a flow to which the received packet belongs from information regarding the process for processing the received packet and supply the flow information to the management processing when determining that the process to be allocated to one of the processors is the process for the received packet, wherein
the management process acquires information indicating a distribution destination processor of the processors corresponding to the flow information from the correspondence and supply the acquired information to the schedule process, and
the setting process provides setting for the schedule process using the information indicating a distribution destination processor of the received packet.

3. The communication apparatus according to claim 1, wherein, while the management process extracts flow information from the received packet, the management process acquires information indicating the distribution destination processor from a transfer process of transferring the received packet distributed to the distribution destination processor by the network interface card to the process for processing the received packet, and stores the flow information and the information indicating the distribution destination processor as the correspondence.

4. The communication apparatus according to claim 3, wherein the received packet is a packet used for establishment of a connection between the communication apparatus and a communication opposite apparatus.

5. The communication apparatus according to claim 1, wherein the one or more processors store information indicating the distribution rule used by the network interface card, and supply, to the schedule process, information indicating the distribution destination processor acquired with the flow information indicating a flow to which the received packet belongs and the information indicating the distribution rule.

6. The communication apparatus according to claim 1, wherein the one or more processors change details of a list that is referred to by the schedule process and register the one or more processors to which the process for processing the received packet can be allocated by registering the distribution destination processor in the list.

7. The communication apparatus according to claim 1, wherein the one or more processors detect a change in the distribution rule used by the network interface card, detect a notification of information indicating a changed distribution rule to the management process, and update the correspondence with the information indicating the changed distribution rule.

8. A processor allocation method for a communication apparatus including a memory and processors coupled to the memory, the method comprising:
distributing a received packet to one of the processors in accordance with a distribution rule;
performing management processing for managing a correspondence between a flow to which the received packet belongs and a distribution destination processor of the processors of the received packet determined in accordance with the distribution rule; and
providing setting for a schedule process configured to allocate a process for processing the received packet to one of the processors so that the process for processing the received packet is allocated to the distribution destination processor of the received packet determined based on the correspondence.
